(19) United States
(12) Patent Application Publication
(10) Pub. No.: US 2016/0213017 A1
(43) Pub. Date: Jul. 28, 2016

(54) METHOD FOR PRODUCING AN INGREDIENT HAVING THE SAME FUNCTIONALITIES AS MELTING SALTS, INGREDIENT AND USE

(71) Applicant: EUROSERUM, Port sur Saône (FR)

(72) Inventors: Delphine Naegele, Pusy Epenoux (FR); Romain Percreaux, Vesoul (FR); Phillipe Vareille, Noidans lès Vesoul (FR); Charlotte De Roquemaurel, Viroflay (FR)

(73) Assignee: EUROSERUM, Port Sur Saône (FR)

(21) Appl. No.: 15/024,944

(22) PCT Filed: Sep. 25, 2014
(86) PCT No.: PCT/FR2014/000215

§ 371 Date: Mar. 25, 2016

(30) Foreign Application Priority Data
Sep. 26, 2013 (FR) 13 02238

(51) Int. Cl. A23C 19/082; A23C 9/146

(52) U.S. Cl. CPC A23C 19/082; A23C 9/146

(57) ABSTRACT

The invention relates mainly to a method for producing an ingredient having the same functionalities as a melting salt, said method comprising at least one step of extracting citrates contained in a dairy fraction. Preferably, the dairy fraction is a milk serum. Advantageously, the step of citrate extraction is carried out by passing a milk serum through an anionic column and recovering the anionic eluate loaded with citrates. The anionic eluate loaded with citrates is then concentrated, mixed with a drying base, then dried, in order to obtain an ingredient in powder form.

The invention mainly pertains to a method for producing an ingredient conferring the same functionalities as melting salts.

The invention further relates to an ingredient capable of being obtained by such a method, as well as to the use of said ingredient as melting salt.

Processed cheeses are traditionally produced by melting of a cheese or a mixture of cheeses potentially with other dairy products added.

The traditional production of processed cheese thus consists of two essential steps.

Firstly, the production of cheese from milk during which the known operations of renneting, coagulation, cutting of coagulum, extracting, pressing and finally ripening succeed one another.

Then, the cheese, or more usually a mixture of ripened cheeses, is ground and mixed with various dairy protein ingredients such as milk powder, caseins or caseinates.

The mixture is then functionalised by concomitant chemical, thermal and mechanical treatments. To this end, melting salts are added to the mixture. The mixture obtained then undergoes a step of stabilisation by cooking-sterilisation then steps of creaming and texturing finalise the reorganisation of the protein network before packaging.

Melting salts confer an emulsifying character to the proteins to assure a smooth and homogenous consistency is obtained, without phase separation.

The melting salts commonly used are citrates, orthophosphates or polyphosphates or a mixture of said components.

Known melting salts are thus synthetic products, the presence of which in cheeses, notably in processed cheeses, needs to be indicated on the label as additives.

Furthermore, the production of these synthetic melting salts engenders the implementation of methods leading to the elaboration of coproducts and polluting wastes.

In this context, the present invention mainly targets a method for producing an ingredient having the same functionalities as melting salts of the prior art and making it possible to overcome the aforementioned drawbacks.

To this end, the method for elaborating an ingredient of the invention having the same functionalities as a melting salt comprises at least one step of extracting citrates contained in a dairy fraction, the calcium content in the final ingredient being controlled throughout said method such that the weight ratio between citrates and calcium in the ingredient is greater than 20.

Control of the calcium content is taken to mean the reduction in the calcium content of the dairy fraction, for example by prior treatment of the milk serum by electrodialysis and/or by passage through a cationic column, or by the control of the content of a component added to the mixture, such that the weight ratio between citrates and calcium in the ingredient remains greater than 20.

The method of the invention may also comprise the following optional characteristics considered in isolation or according to all technically possible combinations thereof:
the dairy fraction is milk serum.
the step of extracting citrates is carried out by passing a milk serum through an anionic column.
a part rich in citrates of the anionic eluate comprising at least 20% dry extract of citrates is obtained at the citrate extraction step.
the part rich in citrates of the anionic eluate is concentrated.
the milk serum is skimmed, dialysed, de-cationed and pasteurised.
the anionic column is regenerated by a basic solution, for example sodium hydroxide or potassium hydroxide, or by salts, for example sodium carbonates.
the pH of the part rich in citrates of the anionic eluate is comprised between 5.5 and 7.
the recovery of the part rich in citrates of the anionic eluate is carried out according to two phases:
   the start of recovery is activated when the percentage dry extract in the anionic eluate reaches a minimum value of at least 2%, and
   the stop of recovery is activated when the instantaneous pH of the anionic eluate reaches a determined maximum threshold value for which the pH of the part rich in citrates of the anionic eluate is comprised between 5.5 and 7.
the conductivity of the anionic eluate is measured and the start and stop of recovery of the anionic eluate are respectively commanded:
   when the conductivity of the anionic eluate reaches a first value corresponding to the minimum value of the percentage dry extract which conditions the start of recovery, and
   when the conductivity of the anionic eluate reaches a second value corresponding for the stop to the determined maximum threshold value of the instantaneous pH of the anionic eluate which conditions the stop of recovery.
the concentration of the anionic eluate loaded with citrates is carried out by vacuum evaporation.
a drying base comprising dairy proteins is mixed with the concentrated anionic eluate loaded with citrates, the level of incorporation of the drying base being adjusted such that the weight ratio between citrates and calcium in the ingredient is comprised between 20 and 130.
the drying base is a dairy product or a dairy fraction, for example serum, demineralised serum, milk, concentrated milk or concentrated skimmed milk.
the drying base is concentrated skimmed milk having a percentage dry extract of 32%, which is added to the anionic eluate in a ratio by weight comprised between 15% and 50%.
the concentrated skimmed milk is added to the anionic eluate in a ratio by weight of 25% when the anionic eluate is a sodium eluate and in a ratio by weight of 35% when the anionic eluate is a potassium eluate.
the mixture comprising the concentrated anionic eluate loaded with citrates and the drying base is dried to obtain an ingredient in powder form.
the drying of the mixture comprising the concentrated anionic eluate loaded with citrates is carried out by atomisation.

The invention also relates to an ingredient in liquid form having the same functionalities as melting salts, which is obtained by the method as described previously before mixing with the drying base, which comprises citrates, lactates and phosphates, and for which the weight ratio between citrates and calcium in said ingredient is greater than 20.

The invention further relates to an ingredient in powder form having the same functionalities as melting salts, obtained by the method as described previously after drying, which comprises citrates, lactates and phosphates, and for which the weight ratio between citrates and calcium in said ingredient is comprised between 20 and 130.

Advantageously, the ingredient in powder form of the invention is controlled for sodium content and comprises a mixture of an ingredient in powder form for which the basic solution used for the regeneration of the anionic column is sodium hydroxide, and an ingredient in powder form for which the basic solution used for the regeneration of the anionic column is potassium hydroxide.

The invention finally relates to the use of such an ingredient as melting salt.

Other characteristics and advantages of the invention will become clear from the description that is given thereof below, by way of indication and in no way limiting, with reference to the appended figures among which:

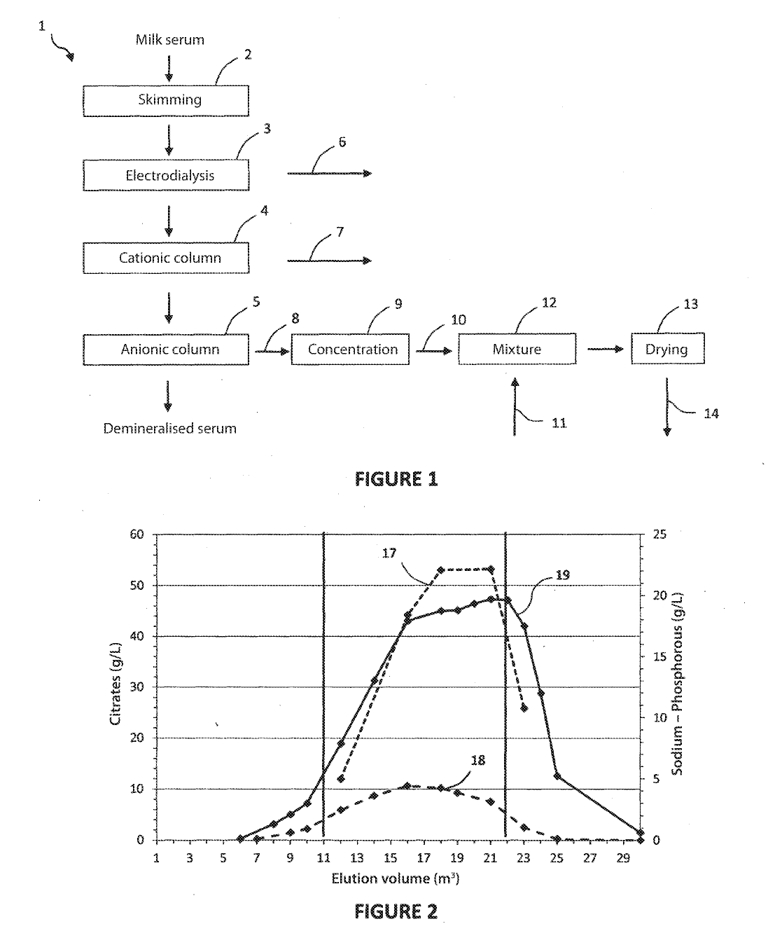

FIG. 1 is a block diagram of the method of the invention,

FIG. 2 is a graph representing the change in the quantities of sodium, citrates, and phosphorous in the anionic eluate of a milk serum obtained by sodium regeneration of the anionic column expressed as a function of the elution volume,

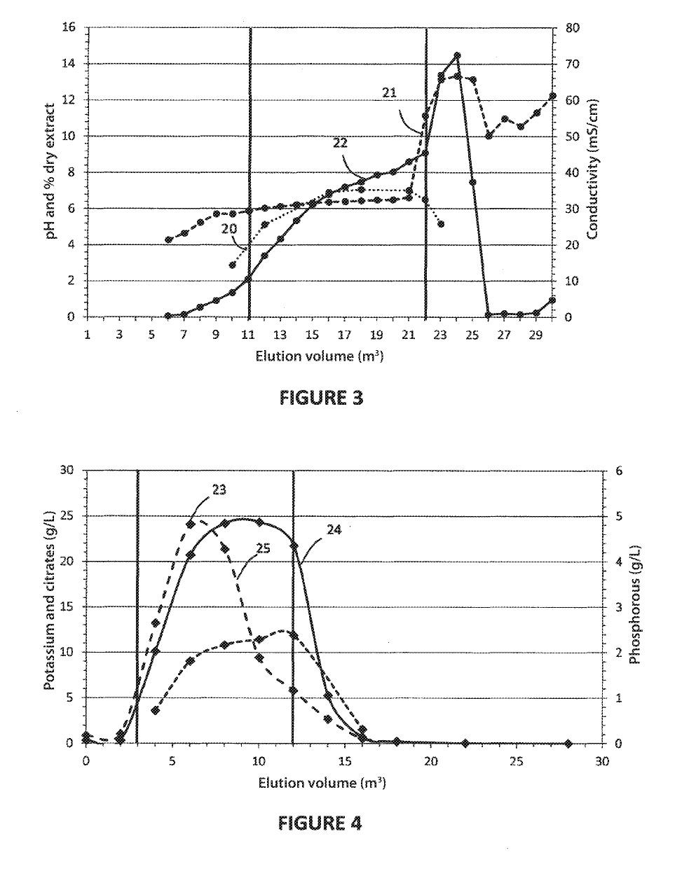

FIG. 3 is a graph representing the change in the pH, the conductivity and the dry extract content of the anionic eluate of a milk serum obtained by sodium regeneration of the anionic column expressed as a function of the elution volume,

FIG. 4 is a graph representing the change in the quantities of potassium, citrates and phosphorous in the anionic eluate of a milk serum obtained by potassium regeneration of the anionic column expressed as a function of the elution volume, and

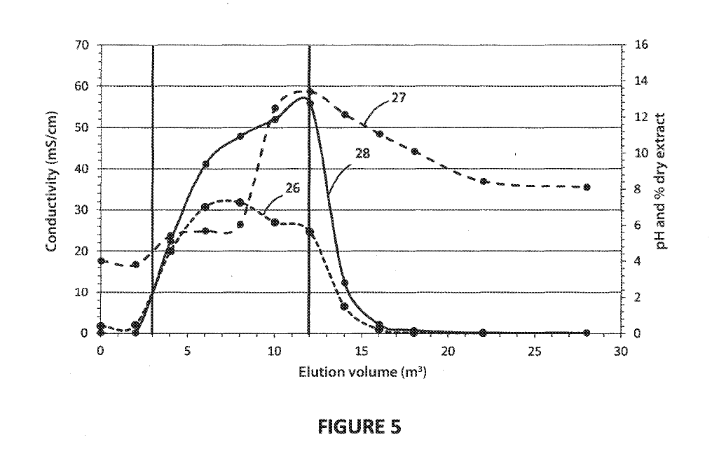

FIG. 5 is a graph representing the change in the pH, the conductivity and the dry extract content of the anionic eluate of a milk serum obtained by potassium regeneration of the anionic column expressed as a function of the elution volume.

The method of the invention essentially consists of a controlled extraction of citrates contained in a dairy fraction. Dairy fraction is taken to mean a product derived from milk.

To this end, the dairy fraction may be a coproduct or a fraction of the coproduct of the operation of coagulation of milk within the context of the production of cheeses, for example milk serum.

The dairy fraction may also be a serum from microfiltration of milk or a dairy product.

The controlled extraction of citrates may be carried out by any suitable method. In the description that follows, said controlled extraction is carried out by passage of a dairy fraction through an anionic column. Said dairy fraction is preferably impoverished or free of caseins which make it possible to facilitate its passage through the anionic column.

In the description that follows, the dairy fraction is milk serum which is naturally rich in salts, in proteins, and in minerals, notably in citrates and in phosphates.

In a known manner, the milk serum is demineralised, notably to control the serum protein, lactose and mineral contents of infant milks.

According to the invention, the ingredient is advantageously obtained from a coproduct of one of the operations of demineralisation of a milk serum.

With reference to FIG. 1, the method of demineralisation of a milk serum 1 notably includes a step of skimming 2 making it possible to reduce the fatty matter content of said milk serum, followed by a step of electrodialysis 3 through which is obtained a dialysed milk serum containing 50 to 60% by weight less minerals.

The skimmed and dialysed milk serum then passes through a cationic column 4 from where it comes out de-cationed, then through an anionic column 5 at the outlet of which the milk serum is called demineralised.

Each of these four steps generates the production of coproducts, namely brine 6 for the electrodialysis 3, a cationic eluate 7 during the passage of the milk serum through a cationic column 4, and an anionic eluate 8 during the passage of the skimmed, dialysed, de-cationed and pasteurised milk serum through the anionic column.

Normally the anionic eluate is sent to a treatment plant or used for manure spreading after having undergone appropriate treatment.

According to the invention, this anionic eluate naturally comprising citrates and phosphates is used to elaborate an ingredient, the functionalities of which are those of melting salts of the prior art.

It is sought to obtain a part sufficiently rich in citrates of the anionic eluate such that the ingredient resulting therefrom has properties comparable to those of known melting salts.

It is furthermore necessary that in the ingredient, citrates are in a majority associated with monovalent elements to be able to have the same functionalities as melting salts. Conversely, their majority association with bivalent elements, such as calcium for example, would cause a loss of their functional character, the ingredient thus no longer being able to have the same functionalities as melting salts. A part rich in citrates is taken to mean an anionic eluate having a concentration of citrates in the dry extract of at least 20%.

Furthermore, it is also sought to obtain an anionic eluate comprising phosphates, the concentration of which in the dry extract is at least 3%.

But it is also necessary to comply with other requirements specific to melting salts, notably in terms of pH.

To this end, when the targeted melting salts are used for the production of processed cheeses, the pH of the anionic eluate loaded with citrates must be comprised between 5.5 and 7. This pH range makes it possible to do away with the later addition of additives for adjusting the pH and thereby to obtain an ingredient not comprising any additive.

It is nevertheless possible to provide for the recovery of eluate having a more basic pH, for example up to 10, but in this hypothesis, the addition of a pH correcting aid must be provided.

It is thus sought to obtain an anionic eluate 8 loaded with citrates but also meeting the aforementioned pH conditions.

Furthermore, obtaining the anionic eluate is conditioned by the regeneration of the anionic column making it possible to free minerals accumulated during the passage of milk serum from particles of resins of the anionic column.

According to the invention, the regeneration of the anionic column is carried out with a basic solution constituted for example of sodium hydroxide or potassium hydroxide. The result is that depending on the case, the anionic eluate obtained comprises either sodium, or potassium. Alternatively, it is possible to provide that the anionic column is regenerated by salts such as sodium carbonates.

According to the invention, a citrate rich part of the anionic eluate derived from the regeneration of the anionic column is thereby recovered. The start and stop of the recovery of said citrate rich part are conditioned by the citrate content of the recovered anionic eluate, but also by the pH of said eluate.

Moreover, this recovery advantageously may also be conditioned by the dry extract content of the recovered anionic eluate. In fact, in the case where the targeted ingredient is in powder form, the higher the dry extract content of the citrate rich part of the anionic eluate, the lower the energy consumption of later operation(s).

Thus, the operation of recovering the citrate rich part may be conditioned by the combination of instantaneous criteria of the anionic eluate at the outlet of the column relating to its dry extract content, its pH and its citrate content and making it possible to obtain a part rich in citrates, pH and dry extract content suited to the elaboration of the ingredient.

These criteria may be illustrated by the instantaneous value of the conductivity of the anionic eluate. Thus, the start and stop of recovery of the anionic eluate may be conditioned by threshold conductivity values of the eluate.

The citrate rich part 8 of the anionic eluate is then concentrated by vacuum evaporation in a falling film vacuum evaporator. This step makes it possible to increase the dry extract content of the citrate rich eluate to avoid overconsumption of energy during the later step of drying.

Alternatively, any other suitable method may be used for this concentration step.

At the outlet of the evaporator, the concentrated citrate rich eluate 10 has a percentage dry extract of the order of 40%.

To avoid problems of hygroscopicity of the ingredient in powder form, a drying base 11 is added to the concentrated citrate rich eluate 10. This drying base advantageously comprises milk proteins. It may thus be constituted of milk, skimmed milk, concentrated skimmed milk, milk serum, demineralised milk serum or a mixture of said components.

It is sought by this addition, and in the first instance, to obtain a powder having a maximum absorbed humidity percentage of 20% and comprising a percentage by weight of around 8% of milk protein.

More generally, the content of drying base which is mixed with the concentrated anionic eluate loaded with citrates is determined in such a way that the weight percentage of milk protein in the ingredient is around 8%.

Furthermore, the drying base comprises a non-negligible part of calcium. Yet, as explained previously, it is essential that a major part of the citrates present in the ingredient are not associated with bivalent elements, and thus in particular with calcium, in order that the ingredient conserves all the functionalities of a melting salt. It is thus also necessary to evaluate the drying base content in this sense.

More precisely, the level of incorporation of the drying base in the anionic eluate is evaluated so that, in the ingredient, the weight ratio with respect to dry extract between citrates and calcium is comprised between 20 and 130. The lower limit of 20 of this ratio corresponds to a level of maximum incorporation of drying base leading to a minimum content of functionalised citrates in the ingredient, and the upper limit of 130 corresponds to a minimum level of incorporation of drying base to avoid problems of hygroscopicity of the ingredient in powder form.

When the drying base used is a concentrated skimmed milk having a percentage dry extract of 32%, this lower limit of 20 of the weight ratio between citrates and calcium in the ingredient corresponds to the addition of said drying base to the anionic eluate in a ratio by weight of 50%. The upper limit of 130, corresponds for its part to the addition of said drying base to the anionic eluate in a ratio by weight of 15%.

Preferentially, concentrated skimmed milk having a percentage dry extract of 32% is added to the concentrated citrate rich eluate 10 in a ratio by weight of 25% for a sodium eluate, and 35% for a potassium eluate, these levels of incorporation assuring both an optimal content of functionalised citrates in the ingredient and an optimal level of milk proteins avoiding problems of hygroscopicity of this same ingredient.

In the case of the use of another type of drying base, those skilled in the art will evaluate the level of incorporation of the drying base so that, on the one hand, the drying base content is sufficient, and so that, on the other hand, in the final ingredient, the weight ratio between citrates and calcium is comprised between 20 and 130. More generally, in the method of the invention, the control of the level of calcium present in the final ingredient must be made in this sense.

The concentrated citrate rich part of the anionic eluate 10 as well as the concentrated skimmed milk are mixed under mechanical stirring.

Optionally, a new step of concentration of the mixture obtained may be provided.

The mixture thereby constituted 12 is then dried by atomisation 13 or by any other suitable method.

The powder obtained 14 thus constitutes an ingredient having the same functionalities as melting salts and being able to be used in the production of processed cheeses instead of melting salts obtained by chemical synthesis of the prior art.

When the powder 14 is derived from sodium regeneration, it comprises a non-negligible sodium content.

Yet in terms of health, the overconsumption of sodium is targeted as being one of the main risk factors of certain diseases, notably cardiovascular diseases.

It is for this reason that the use of a powder 14 derived from potassium regeneration makes it possible to control the sodium content of the ingredient of the invention.

To do so, a mixture is formed between the ingredient in powder form derived from sodium regeneration and the ingredient in powder form derived from potassium regeneration, the respective contents of the two powders being adjusted according to the targeted ratio between the sodium and potassium contents. The ingredient of the invention 14 is then obtained, the sodium content of which is precisely controlled.

The ingredient of the invention may also be in liquid form. In this hypothesis, the ingredient is constituted of the citrate rich part 8 of the anionic eluate or of the concentrated citrate rich part 10 of the anionic eluate at the outlet of the thermal evaporator.

In the same way as for an ingredient in powder form, the mixture between the citrate rich part of the liquid eluate obtained by sodium regeneration and the citrate rich part of the liquid eluate obtained by potassium regeneration makes it possible to control the sodium content of the liquid ingredient.

When the ingredient is in liquid form, no drying base is added which results in the absence of calcium in the ingredient except in the form of traces.

The operation of recovering the citrate rich part of the anionic eluate at the outlet of the anionic column is described hereafter as an example.

With reference to FIG. 2, the change in the concentration is measured expressed in grams per litre of citrates 17, phosphorous 18 and sodium 19 contained in the anionic eluate derived from regeneration of the anionic column by sodium hydroxide and as a function of the elution volume.

The anionic column used for this example comprises 8000 litres of resin.

A shift is observed in the recovery of minerals contained in the anionic eluate, said shift being mainly attributed to the dead volume of the column. For the anionic column specifically used, minerals appear from around 7 cubic metres of anionic eluate.

Their content increases with elution volume, to decrease from an elution volume of around 21 cubic metres.

With reference to FIG. 3, the change in the dry extract content 20 of the anionic eluate is compliant with the change in the content of the components of the eluate.

When it is wished to produce the ingredient in powder form, a step of drying, which will be described hereafter, must be provided.

To this end, it is sought to obtain an economically dryable product. The result is that the anionic eluate must comprise a percentage dry extract greater than 2% and preferably of the order of 5 to 6%.

The start of recovery of the anionic eluate is thus conditioned by the percentage dry extract of the anionic eluate.

According to this example, the recovery of the anionic eluate is carried out from an elution volume of 11 cubic metres corresponding to a percentage dry extract of 4% in the anionic eluate.

As regards the change in the pH 21 as a function of elution volume, it may be noted that the pH is relatively stable between 6 and 6.2 up to an elution volume of 21 cubic metres, then increases rapidly to reach a pH of 13 for an elution volume of 23 cubic metres. This increase is attributed to the end of the phenomenon of ion exchange, there is then a massive influx of hydroxide ions (OH⁻) stemming from sodium hydroxide. When it is wished to avoid any later pH adjustment, the stop of the recovery of the anionic eluate is set at 22 cubic metres.

Since the increase in pH corresponds to the lowering of the mineral content in the eluate (FIG. 2), the result is that the anionic eluate which is recovered is not just rich in citrates, but also optimal for the later operation of drying and complying with requirements in terms of pH.

In the case where a pH adjustment is carried out later, for example by addition of hydrochloric acid, the stop of recovery of the anionic eluate may be shifted towards a greater elution volume of 23 to 24 cubic metres, thus making it possible to increase the citrates content recovered in the anionic eluate.

With reference to FIG. 3, it may be noted that the conductivity 22 of the anionic eluate reflects both the increase in the dry extract content at the start of recovery, but also the increase in pH at the end of recovery. It is thus advantageous to carry out a calibration of the column to determine the value of the conductivity from which the anionic eluate is recovered and the value of the conductivity for which the recovery is stopped, these values taking account of the percentage dry extract and pH thresholds explained previously.

In this example, the recovery will begin to be carried out for a conductivity of 10 mS/cm and stopped when the anionic eluate has a conductivity of 45 mS/cm.

With reference to FIG. 4, the change in citrate 23, potassium 24 and phosphorous 25 contents, when the basic solution used to regenerate the anionic column is potassium hydroxide, is similar to that obtained for regeneration with sodium hydroxide.

A shift of the citrate 23, potassium 24 and phosphorous 25 peaks towards lower elution volumes may nevertheless be noted. The start of the recovery of the anionic eluate will thus be adapted to lower elution volumes.

As in the case of regeneration by the sodium eluate, account is taken of the change in the percentage dry extract 26 and pH 27 represented in FIG. 5 to set the start and stop of recovery.

More precisely and for an anionic column of 8000 litres of resin regenerated with potassium hydroxide, the start of recovery of the anionic eluate will be set at an elution volume of 3 cubic metres corresponding to a percentage dry extract of 4.25, and the stop of recovery of the eluate set at 12 cubic metres.

As for anionic regeneration, these values make it possible to recover an eluate which is both rich in citrates, but which is also optimal for the later operation of drying and complies with requirements in terms of pH.

Furthermore, since the conductivity 28 is also in phase with the increase in the percentage dry extract and the increase in pH, conductivity values corresponding to start elution volumes of 3 cubic metres and stop of recovery of 12 cubic metres are determined.

In this example, recovery will begin to be carried out for a conductivity of around 2.2 mS/cm and stopped when the anionic eluate has a conductivity of 13 mS/cm.

The result is that for a given anionic column, the start and the stop of recovery of the anionic eluate may be activated respectively at a first conductivity which is determined as a function of the dry extract content in the eluate, and at a second conductivity which is determined as a function of the rise in pH, as explained previously.

The control of the start and stop of recovery of the anionic eluate regenerated by sodium hydroxide or potassium hydroxide thus makes it possible to obtain an anionic citrate rich eluate of which the pH, the percentage dry extract as well as the concentrations of the components are presented in Table 1 below.

TABLE 1

| | Sodium eluate | Potassium eluate |
|---|---|---|
| pH | 6.09 | 6.2 |
| Dry extract (%) | 7.2 | 5.9 |
| Sodium (in % dry extract) | 22.74 | 0.32 |
| Potassium (in % dry extract) | ≈0.4 | 32.06 |
| Lactates (in % dry extract) | 7.2 | 7.3 |
| Phosphorous (in % dry extract) | 5.05 | 6.09 |
| Citrate (in % dry extract) | 38.7 | 30.91 |

The presence of lactates may be noted in the potassium and sodium eluates, said lactates stemming from the milk serum used to elaborate the ingredient of the invention. Lactates will also be present when the dairy fraction used is different from a milk serum.

Consequently, the potassium and sodium eluates, as well as the ingredient of the invention, whether it is in liquid form or in powder form and whether it is obtained from milk serum or another dairy fraction, are thus notably characterised by the presence of lactates in addition to citrates and phosphates.

The absence of calcium in the anionic eluate may furthermore be noted, calcium having been extracted beforehand from the milk serum during electrodialysis and during passage through the cationic column.

Tests have been carried out to compare the texture of a processed cheese in which the melting salts of the invention have been used in the formulation, with a processed cheese comprising commercially available melting salts.

The elaboration of processed cheeses is carried out according to known methods described in the preamble of the description.

Table 2 below presents the results in terms of hardness, adhesiveness, cohesiveness and elasticity of processed cheeses in which the melting salts of the invention are derived either from sodium regeneration or potassium regeneration. These results are compared with control processed cheeses prepared with traditional melting salts.

It may be noted that all the results in terms of hardness, adhesiveness, cohesiveness and elasticity are close to the results obtained for the control.

TABLE 2

| | Hardness | Adhesiveness | | Elasticity |
|---|---|---|---|---|
| | (Newtons) | (milliJoules) | Cohesiveness | (millimetres) |
| Control | 0.71 | 2.97 | 0.77 | 11.79 |
| Sodium | 0.79 | 2.68 | 0.86 | 11.83 |
| recovery | | | | |
| Potassium | 0.66 | 2.95 | 0.90 | 11.55 |
| recovery | | | | |

The ingredient of the invention is thus obtained from a natural product, milk serum or any other dairy fraction, preferably skimmed, dialysed, de-cationed and pasteurised milk serum and has properties comparable to melting salts of the prior art.

Thus, the labelling of a cheese, notably a processed cheese, comprising the ingredient of the invention will not require an additive marking on the label, said marking being obligatory when synthetic melting salts are used.

Furthermore, the method for obtaining the ingredient of the invention is integrated in the method for elaborating a demineralised milk serum by making beneficial use of a coproduct of this method and thereby reducing the production of polluting products.

1. Method for elaborating an ingredient rich in citrates having the same functionalities as a melting salt, the method comprising:
extracting citrates from a dairy fraction to obtain a final ingredient, a calcium content in the final ingredient being controlled throughout the method so that a weight ratio between citrates and calcium in the final ingredient is greater than 20.

2. Method according to claim 1, wherein the dairy fraction is milk serum.

3. Method according to claim 1, wherein the extracting of the citrates is carried out by passing milk serum through an anionic column.

4. Method according to claim 3, wherein a part rich in citrates of an anionic eluate comprising at least 20% dry extract of citrates is obtained at the citrate extraction.

5. Method according to claim 4, characterised in that the part rich in citrates of the anionic eluate is concentrated.

6. Method according to claim 2, wherein the milk serum is skimmed, dialysed, de-cationed and pasteurized.

7. Method according to claim 3, wherein the anionic column is regenerated by a basic solution, for example sodium hydroxide or potassium hydroxide or by salts, for example sodium carbonates.

8. Method according to claim 4, wherein a pH of the part rich in citrates of the anionic eluate is comprised between 5.5 and 7.

9. Method according to claim 4, wherein a recovery of the part rich in citrates of the anionic eluate is carried out by:
activating a start of the recovery when a percentage as a dry extract in the anionic eluate reaches a minimum value of at least 2%, and
activating a stop of the recovery when an instantaneous pH of the anionic eluate reaches a determined maximum threshold value for which the pH of the part rich in citrates of the anionic eluate is comprised between 5.5 and 7.

10. Method according to claim 9, wherein a conductivity of the anionic eluate is measured and the start and the stop of the recovery of the anionic eluate are respectively commanded:
when the conductivity of the anionic eluate reaches a first value corresponding to the minimum value of the percentage as a dry extract which conditions the start of recovery, and
when the conductivity of the anionic eluate reaches a second value corresponding to the stop at the determined maximum threshold value of the instantaneous pH of the anionic eluate which conditions the stop of recovery.

11. Method according to claim 4, wherein a concentration of the anionic eluate loaded with citrates is carried out by vacuum evaporation.

12. Method according to claim 4, wherein a drying base comprising dairy proteins is mixed with the concentrated anionic eluate loaded with citrates, the level of incorporation of the drying base being adjusted so that a weight ratio between citrates and calcium in the final ingredient is comprised between 20 and 130.

13. Method according to claim 12, wherein the drying base is a dairy product or a dairy fraction.

14. Method according to claim 13, wherein the drying base is concentrated skimmed milk having a percentage as a dry extract of 32%, which is added to the anionic eluate in a ratio by weight comprised between 15% and 50%.

15. Method according to claim 14, wherein the concentrated skimmed milk is added to the anionic eluate in a ratio by weight of 25% when the anionic eluate is a sodium eluate and in a ratio by weight of 35% when the anionic eluate is a potassium eluate.

16. Method according to claim 12, wherein a mixture comprising (i) the concentrated anionic eluate loaded with citrates, and (ii) the drying base, is dried to obtain the final ingredient in powder form.

17. Method according to claim 16, wherein the drying of the mixture comprising the concentrated anionic eluate loaded with citrates is carried out by atomisation.

18. Ingredient having the same functionalities as melting salts,
wherein the ingredient is in liquid form,
wherein the ingredient comprises citrates, lactates and phosphates, and
wherein a weight ratio between citrates and calcium in the ingredient is greater than 20.

19. Ingredient having the same functionalities as melting salts,
wherein the ingredient is in powder form,
wherein the ingredient comprises citrates, lactates and phosphates, and
wherein a weight ratio between citrates and calcium in the ingredient is comprised between 20 and 130.

20. Ingredient having the same functionalities as melting salts,
wherein the ingredient is in powder form,
wherein the ingredient comprises citrates, lactates and phosphates, and
wherein a weight ratio between citrates and calcium in the ingredient is comprised between 20 and 130,
wherein the ingredient is obtained by the method of claim 16, and
wherein the ingredient comprises a mixture of (I) a first ingredient for which a first basic solution used for the regeneration of the anionic column is sodium hydroxide, and (ii) a second ingredient for which a second basic solution used for the regeneration of the anionic column is potassium hydroxide.

21. Method of melting a component comprising contacting the component with the ingredient according to claim 18.
